(19) United States
(12) Patent Application Publication
(10) Pub. No.: US 2023/0122030 A1
(43) Pub. Date: Apr. 20, 2023

(54) POLYESTER COMPOSITION AND MANUFACTURING METHOD THEREOF

(71) Applicant: NAN YA PLASTICS CORPORATION, TAIPEI (TW)

(72) Inventors: Te-Chao Liao, TAIPEI (TW); Chun-Che Tsao, TAIPEI (TW); Yueh-Shin Liu, TAIPEI (TW); Chuanjyun Wang, TAIPEI (TW)

(73) Assignee: NAN YA PLASTICS CORPORATION, TAIPEI (TW)

(21) Appl. No.: 17/529,198

(22) Filed: Nov. 17, 2021

(30) Foreign Application Priority Data
Oct. 15, 2021 (TW) 110138393

(51) Int. Cl. C08L 67/02; C08G 63/183; B29C 48/00

(52) U.S. Cl. CPC C08L 67/02; C08G 63/183; B29C 48/022; C08L 2205/025; C08L 2203/16; C08L 2201/10

(57) ABSTRACT

Provided is a polyester composition having the following physical properties. When the polyester composition is formed into a film with a thickness of 3.2 mm, the film has a light transmittance of greater than 90% in a visible spectrum in a thickness direction, and the film has an impact strength of greater than 3.50 kJ/m at −20° C.

### CROSS-REFERENCE TO RELATED APPLICATION

This application claims the priority benefit of Taiwanese application no. 110138393, filed on Oct. 15, 2021. The entirety of the above-mentioned patent application is hereby incorporated by reference herein and made a part of this specification.

### BACKGROUND

### Technical Field

The disclosure relates to a polyester composition and a manufacturing method thereof, and particularly relates to a polyester composition having high penetration under visible light and having good impact strength, and a manufacturing method thereof.

### Related Art

With the growing need for logistics services in the market, certain products need to be refrigerated and stored at low temperatures. Thus, it is necessary for a storage box and/or packaging material used in cold chain logistics to have good mechanical strength at low temperatures, so as to reduce the possibility of product damage or breakage during low temperature storage or transportation.

Currently, the most common materials used in packaging and storage boxes in low temperature logistics include polypropylene (PP). However, due to its tendency to crystallize, polypropylene is often reduced in transparency (especially when used under visible light for human observation or recognition). As a result, an article stored in a packaging or storage box made of polypropylene cannot be easily observed or recognized. In addition, in a low temperature environment (for example, at −20° C. to −8° C., which is often required for low temperature transportation or storage), polypropylene may undergo brittle fracture due to a significant drop in impact strength.

In view of the above, how to select or form suitable plastics to adapt to the aforementioned low temperature conditions has become an urgent problem to be solved.

### SUMMARY

The disclosure provides a polyester composition and a manufacturing method thereof, in which the polyester composition has high penetration under visible light and has good impact strength.

A polyester composition according to the disclosure has the following physical properties. A film formed from the polyester composition and having a thickness of 3.2 millimeters (mm) has a light transmittance of greater than 90% in a visible spectrum in a thickness direction and an impact strength of greater than 3.50 kJ/m at −20° C.

In an embodiment of the disclosure, the polyester composition is at least formed of a polyester mixture. The polyester mixture includes: polyethylene terephthalate in an amount of 65 to 94 parts by weight in the polyester mixture; and poly(ethylene terephthalate-co-1,4-cyclohexylenedimethylene terephthalate) in an amount of 5 to 30 parts by weight in the polyester mixture.

In an embodiment of the disclosure, the polyester mixture further includes: an antioxidant in an amount of 0.5 to 2 parts by weight in the polyester mixture; and/or a slip agent in an amount of 0.5 to 2 parts by weight in the polyester mixture.

In an embodiment of the disclosure, the polyester composition is at least formed by a reactive extrusion method. The reactive extrusion method includes the following. An extruder is provided. A polyester mixture is fed into the extruder for extrusion to form the polyester composition.

In an embodiment of the disclosure, the extruder includes a heating area, and the polyester mixture is fed into the extruder for hot pressing reaction.

In an embodiment of the disclosure, a heating temperature in the heating area is increasing.

In an embodiment of the disclosure, the heating area includes an initial heating area and a final heating area. A lowest temperature in the final heating area is higher than or equal to a highest temperature in the initial heating area.

A polyester composition according to the disclosure is at least formed by a reactive extrusion method. The reactive extrusion method includes the following. An extruder is provided. A polyester mixture is fed into the extruder for extrusion to form the polyester composition. The polyester mixture includes: polyethylene terephthalate in an amount of 65 to 94 parts by weight in the polyester mixture; and poly(ethylene terephthalate-co-1,4-cyclohexylenedimethylene terephthalate) in an amount of 5 to 30 parts by weight in the polyester mixture.

A manufacturing method of a polyester composition according to the disclosure includes the following. An extruder is provided. A polyester mixture is fed into the extruder for extrusion to form the polyester composition. The polyester mixture includes: polyethylene terephthalate in an amount of 65 to 94 parts by weight in the polyester mixture; and poly(ethylene terephthalate-co-1,4-cyclohexylenedimethylene terephthalate) in an amount of 5 to 30 parts by weight in the polyester mixture.

A manufacturing method of a polyester composition according to the disclosure includes the following. An extruder is provided. A polyester mixture is fed into the extruder for extrusion to form the polyester composition. The polyester composition has the following physical properties. A film formed from the polyester composition and having a thickness of 3.2 mm has a light transmittance of greater than 90% in a visible spectrum in a thickness direction and an impact strength of greater than 3.50 kJ/m at −20° C.

Based on the above, in the polyester composition (which may be in the form of chips or flakes) formed by the manufacturing method of a polyester composition according to the disclosure has high penetration under visible light and has good impact strength.

### BRIEF DESCRIPTION OF THE DRAWINGS

FIG. 1 is a schematic flowchart of a part of a manufacturing method of a polyester composition according to an embodiment of the disclosure.

FIG. 2 is a schematic flowchart of a part of a manufacturing method of a polyester composition according to an embodiment of the disclosure.

### DESCRIPTION OF THE EMBODIMENTS

In the following detailed description, for the sake of illustration and not limitation, exemplary embodiments disclosing specific details are set forth to provide a thorough understanding of various principles of the disclosure. However, it will be apparent to one of ordinary skill in the art, having had the benefit of the disclosure, that the disclosure may be practiced in other embodiments that depart from the specific details disclosed herein. Moreover, descriptions of well-known devices, methods and materials may be omitted so as not to obscure the description of various principles of the disclosure.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Herein, non-limiting terms (such as may, can, for example, or other similar terms) are unnecessary or optional implementations, inclusions, additions or existences.

Unless otherwise defined, all terms (including technical and scientific terms) used herein have the same meaning as commonly understood by one of ordinary skill in the art. Any term that is defined in a general dictionary shall be construed to have the same meaning in the context of the relevant art, and, unless otherwise defined explicitly, shall not be interpreted to have an idealistic or excessively formalistic meaning.

### Preparation of Polyester Mixture

In the present embodiment, a polyester mixture may include polyethylene terephthalate (PET) and poly(ethylene terephthalate-co-1,4-cyclohexylenedimethylene terephthalate) (PETG). When the amount of the polyester mixture is regarded as 100 parts by weight, the amount of PET may be 65 to 94 parts by weight, and the amount of PETG may be 5 to 30 parts by weight.

In one embodiment, when the amount of the polyester mixture is regarded as 100 parts by weight, the amount of PET may be more than or equal to 67 parts by weight, and/or less than or equal to 92 parts by weight. Preferably, when the amount of the polyester mixture is regarded as 100 parts by weight, the amount of PET may be 67 to 92 parts by weight.

In one embodiment, if the proportion of PET is excessively high (for example, more than 95 wt %) and/or the proportion of PETG is excessively low (for example, less than 5 wt %), light transmittance of the resulting polyester composition (or the further resulting film) may be reduced; and/or impact strength (for example, the impact strength at about −20° C.) of the resulting polyester composition (or the further resulting film) may be reduced.

In one embodiment, if the proportion of PET is excessively low (for example, less than 65 wt %) and/or the proportion of PETG is excessively high (for example, more than 30 wt %), haze of the resulting polyester composition (or the further resulting film) may be increased, thereby reducing the visibility in product application; and/or tensile strength or bending strength may be reduced, thereby increasing processing difficulty.

In the present embodiment, PET may have an intrinsic viscosity (IV) of 0.6 to 1.0 dL/g, and/or a melting point of 253° C. to 255° C.

In addition, the disclosure does not impose any limitation on the method of obtaining PET. For example, PET may be obtained by polyester reaction between purified terephthalic acid (PTA) and ethylene glycol (EG), or may be obtained by an appropriate recycling method. In one embodiment, PET may include virgin polyester chips, physically recycled polyester chips, chemically recycled polyester chips, or a combination of the above.

In one embodiment, the polyester mixture may further include an antioxidant and/or a slip agent. When the amount of the polyester mixture is regarded as 100 parts by weight, the amount of the antioxidant may be 0.5 to 2 parts by weight, and/or the amount of the slip agent may be 0.5 to 2 parts by weight.

In one embodiment, the antioxidant may include tris(2,4-di-tert-butyl)phenyl phosphite (CAS: 31570-04-4), pentaerythritol tetrakis(3-(3,5-di-tert-butyl-4-hydroxyphenyl)propionate) (CAS: 6683-19-8) or a combination of the above. However, the disclosure is not limited thereto.

In one embodiment, the antioxidant may reduce the possibility of oxidation, cracking due to exposure to oxygen or modification due to exposure to oxygen occurring in a material (for example, the polyester mixture in granular or powder form) between steps of a later-described preparation process, during the preparation process, and/or after completion of the preparation process.

In one embodiment, the slip agent may include a fatty acid and metal soaps thereof (for example but not limited to, fatty acid potassium or fatty acid sodium), esters, amides, paraffin or hydrocarbons, or a combination of the above. However, the disclosure is not limited thereto.

In one embodiment, the slip agent may reduce friction between materials (for example but not limited to, between each particle of the polyester mixture in granular or powder form) and/or between a material and an apparatus (for example, a part of a later-described extruder).

### Preparation of Polyester Composition

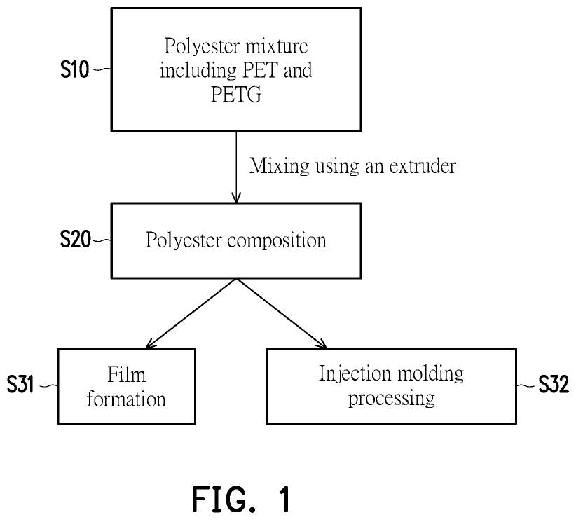

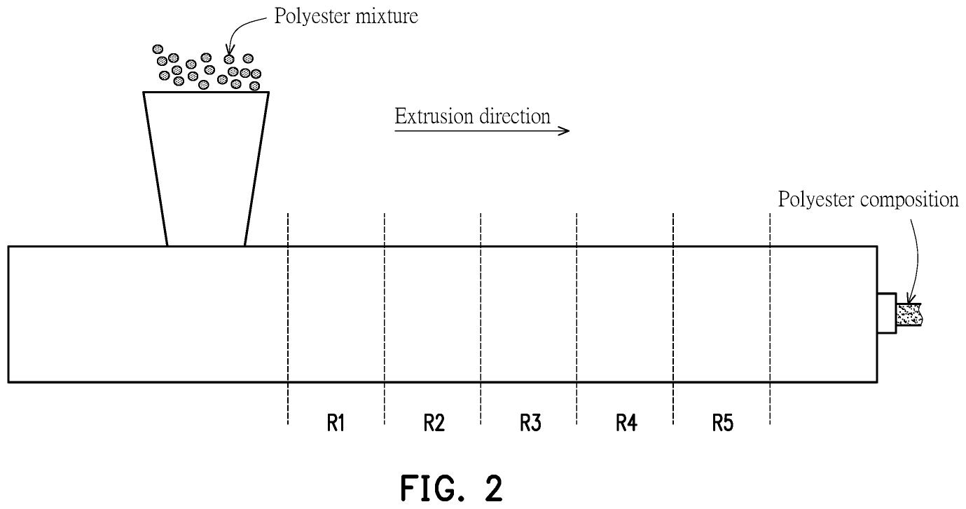

Referring to steps S10 to S20 in FIG. 1 together with FIG. 2, a polyester mixture may be fed in an extruder (as shown in FIG. 2) for extrusion, and a polyester composition is formed by a reactive extrusion method.

The extruder is, for example, a commercially available single screw extruder (SSE), twin screw extruder (TSE) or any other similar screw extruder. However, the disclosure is not limited thereto. Details of the structure and/or operation method of the above-mentioned commercially available screw extruder will be omitted herein.

In one embodiment, at least one feeder (for example, side feeder) may be attached to the extruder. The feeder may be a loss-in-weight feeder equipped with a loss-in-weight meter. The feeder may be a common commercially available device and/or optional accessory. That is, the components of the polyester mixture may be mixed before feeding, or may be fed into the extruder by different feeders and mixed in the extruder.

In the present embodiment, as shown in FIG. 2, the extruder may have a heating area. In this way, after the polyester mixture is fed into the extruder, the polyester mixture in the extruder may be correspondingly extruded and heated, so as to form a corresponding polyester composition by hot pressing reaction. Then, the polyester composition is squeezed or extruded out. In the present embodiment, a heating temperature in the heating area may be 240° C. to 280° C.

In one embodiment, the polyester composition squeezed or extruded out may be formed into polyester chips by granulation.

In one embodiment, the heating temperature in the heating area is increasing along an extrusion direction.

In one embodiment, the heating area may include an initial heating area and a final heating area. A lowest temperature in the final heating area is higher than or equal to a highest temperature in the initial heating area.

Taking FIG. 2 as an example, along the extrusion direction (for example, a direction from where the polyester mixture is fed in toward where the polyester composition is squeezed or extruded out), the heating area may include a first heating area R1, a second heating area R2, a third heating area R3, a fourth heating area R4, and a fifth heating area R5. The heating temperature in the first heating area R1 may be 240° C. to 260° C., the heating temperature in the second heating area R2 may be 245° C. to 265° C., the heating temperature in the third heating area R3 may be 250° C. to 270° C., the heating temperature in the fourth heating area R4 may be 250° C. to 270° C., and the heating temperature in the fifth heating area R5 may be 260° C. to 280° C.

Physical Properties of Polyester Composition

A polyester composition formed by the above-mentioned method may have at least one of the following physical properties. It is worth noting that the following physical properties can be obtained by the mentioned standard test methods. Thus, the corresponding test apparatuses and/or test means will not be described in detail.

Tensile strength of the polyester composition may be measured based on the ASTM-D638 standard test method defined by the American Society for Testing and Materials (ASTM), and may be 55 to 61 megapascals (MPa; 1 MPa=1×10⁶ Pa), such as for example, 55.7 to 60.8 MPa.

Bending strength of the polyester composition may be measured based on the ASTM-D790 standard test method defined by ASTM, and may be 85 to 89 MPa, such as for example, 85.1 to 88.1 MPa.

Bending modulus of the polyester composition may be measured based on the ASTM-D790 standard test method defined by ASTM, and may be 2100 to 2400 MPa, such as for example, 2200 to 2300 MPa.

Izod impact strength of the polyester composition may be measured based on the ASTM-D256 standard test method defined by ASTM, and may be 3.3 to 5.7 kg-cm/cm, such as for example, 3.48 to 5.52 kg-cm/cm.

Specific gravity of the polyester composition may be measured based on the ASTM-D792 standard test method defined by ASTM, and may be 1.30 to 1.35 g/cm³, such as for example, 1.31 to 1.32 g/cm³.

Application of Polyester Composition

The polyester composition may be used in any other suitable applications in any suitable manner. For example, as shown in steps S20 to S31 in FIG. 1, the polyester composition may be formed into a film by a common co-extrusion method. For another example, as shown in steps S20 to S32 in FIG. 1, the polyester composition may be formed into an object having a specific shape or form by a common injection molding processing method.

In the present embodiment, the polyester composition may be formed into a corresponding film. A film formed from the polyester composition by the above-mentioned method and having a thickness of 3.2 mm may have at least one of the following physical properties.

Transparency of the film may be measured based on the ASTM-D1003 standard test method defined by ASTM. The film having a thickness of 3.2 mm may have transparency of greater than 89%, such as for example, greater than or equal to 90.13%, in a thickness direction thereof.

Haze of the film may be measured based on the ASTM-D1003 standard test method defined by ASTM. The film having a thickness of 3.2 mm may have haze of 2.0% to 6.5%, such as for example, 2.14% to 6.09%.

Impact strength of the film at a temperature of −20° C. may be measured based on the ASTM-D256 standard test method defined by ASTM. The film having a thickness of 3.2 mm may have impact strength of 3 to 9 kJ/m, such as for example, 3.59 to 8.90 kJ/m, at −20° C.

In summary, the polyester composition (which may be in the form of chips or flakes) formed by the manufacturing method of a polyester composition of the aforementioned embodiments of the disclosure may have good impact strength, relatively high visible light transmittance, and relatively low haze. In addition, the polyester composition formed by the manufacturing method of the aforementioned embodiments may be directly or indirectly applied to an existing plastic film or injection molding processing apparatus or technology, and is relatively simple in terms of manufacturing process and/or application. The polyester composition may further be processed into other consumer, industrial or suitable products.

### Examples

Examples are shown below to specifically describe the disclosure. However, the disclosure is not limited in any way to the following examples.

In each example, the weight ratios of polyethylene terephthalate (PET), poly(ethylene terephthalate-co-1,4-cyclohexylenedimethylene terephthalate) (PETG), the antioxidant and the slip agent in the polyester mixture are as shown in Table 1.

In Table 1, polyethylene terephthalate (indicated by PET in Table 1) may be polyester chips sold by Nan Ya Plastics Corporation, and may have an intrinsic viscosity of 0.6 to 1.0 dL/g and a melting point of 253° C. to 255° C.

In Table 1, poly(ethylene terephthalate-co-1,4-cyclohexylenedimethylene terephthalate) (indicated by PETG in Table 1) may be an Eastar™ series product sold by Eastman Chemical Company.

In Table 1, the antioxidant and/or the slip agent used may be as described above.

By the aforementioned method, the polyester mixture of each example may be formed into a corresponding polyester composition, or may further be formed into a film having a thickness of 3.2 mm.

In Table 1, the physical properties of each polyester composition and/or each film may be measured as described above.

TABLE 1

| | Example | Example | Example | Example |
|---|---|---|---|---|
| | 1 | 2 | 3 | 4 |
| PET | 92 | 81 | 73 | 67 |
| PETG | 5 | 15 | 25 | 30 |
| Antioxidant | 2 | 2 | 1 | 1 |
| Slip agent | 1 | 2 | 1 | 2 |
| Specific gravity | 1.31 | 1.31 | 1.32 | 1.32 |
| (g/cm³) | | | | |
| Izod impact strength | 3.48 | 3.58 | 4.46 | 5.52 |
| (kg-cm/cm) | | | | |
| Tensile strength (MPa) | 57.0 | 60.8 | 59.8 | 55.7 |
| Bending strength (MPa) | 86.8 | 88.1 | 87.6 | 85.1 |
| Bending modulus (MPa) | 2200 | 2290 | 2230 | 2300 |
| Transparency (%) | 90.13 | 92.23 | 94.29 | 96.22 |
| Haze (%) | 2.14 | 3.91 | 5.65 | 6.09 |
| Impact strength | 3.59 | 6.30 | 7.53 | 8.90 |
| (kJ/m) at −20° C. | | | | |

In each of the above-mentioned examples (for example but not limited to, Example 1 to Example 4), the polyester composition and/or film exhibited good impact strength (especially at −20° C., but the disclosure is not limited thereto), relatively high mechanical strength, relatively high visible light transmittance and/or relatively low haze.

In addition, the polyester composition and/or film of each of the aforementioned examples may be directly or indirectly applied to an existing plastic film or injection molding processing apparatus or technology, and is relatively simple in terms of manufacturing process and/or application. The polyester composition may further be processed into other consumer, industrial or suitable products.

### INDUSTRIAL APPLICABILITY

In addition, the polyester composition (which may be in the form of chips or flakes) formed by the manufacturing method of the aforementioned embodiments may be directly or indirectly applied to an existing plastic film or injection molding processing apparatus or technology, and may further be processed into other consumer, industrial or suitable products. Examples thereof include but are not limited to: a material for injection molding for making a storage box, a film having low temperature impact strength and high penetration under visible light, and/or a packaging material for cold chain logistics, prepared by co-extrusion technology.

1. A polyester composition having following physical properties:
a film formed from the polyester composition and having a thickness of 3.2 mm having a light transmittance of greater than 90% in a visible spectrum in a thickness direction of the film; and
the film having an impact strength of greater than 3.50 kJ/m at −20° C.

2. The polyester composition according to claim 1, at least formed of a polyester mixture, wherein the polyester mixture comprises:
polyethylene terephthalate in an amount of 65 to 94 parts by weight in the polyester mixture; and
poly(ethylene terephthalate-co-1,4-cyclohexylenedimethylene terephthalate) in an amount of 5 to 30 parts by weight in the polyester mixture.

3. The polyester composition according to claim 2, at least formed by a reactive extrusion method comprising:
providing an extruder; and
feeding the polyester mixture into the extruder for extrusion to form the polyester composition.

4. The polyester composition according to claim 2, wherein the polyester mixture further comprises:
an antioxidant in an amount of 0.5 to 2 parts by weight in the polyester mixture; or
a slip agent in an amount of 0.5 to 2 parts by weight in the polyester mixture.

5. The polyester composition according to claim 4, at least formed by a reactive extrusion method comprising:
providing an extruder; and
feeding the polyester mixture into the extruder for extrusion to form the polyester composition.

6. The polyester composition according to claim 5, wherein the extruder comprises a heating area, and the polyester mixture is fed into the extruder for hot pressing reaction.

7. The polyester composition according to claim 6, wherein a heating temperature in the heating area is increasing.

8. The polyester composition according to claim 6, wherein the heating area comprises an initial heating area and a final heating area, and a lowest temperature in the final heating area is higher than or equal to a highest temperature in the initial heating area.

9. A polyester composition at least formed by a reactive extrusion method comprising:
providing an extruder; and
feeding a polyester mixture into the extruder for extrusion to form the polyester composition, wherein the polyester mixture comprises:
polyethylene terephthalate in an amount of 65 to 94 parts by weight in the polyester mixture; and
poly(ethylene terephthalate-co-1,4-cyclohexylenedimethylene terephthalate) in an amount of 5 to 30 parts by weight in the polyester mixture.

10. A manufacturing method of a polyester composition, comprising:
providing an extruder; and
feeding a polyester mixture into the extruder for extrusion to form the polyester composition, wherein:
the polyester composition has following physical properties: a film formed from the polyester composition and having a thickness of 3.2 mm having a light transmittance of greater than 90% in a visible spectrum in a thickness direction of the film; and the film having an impact strength of greater than 3.50 kJ/m at −20° C.; and/or
the polyester mixture comprises: polyethylene terephthalate in an amount of 65 to 94 parts by weight in the polyester mixture; and poly(ethylene terephthalate-co-1,4-cyclohexylenedimethylene terephthalate) in an amount of 5 to 30 parts by weight in the polyester mixture.
